(19) United States
(12) Patent Application Publication
(10) Pub. No.: US 2026/0036964 A1
(43) Pub. Date: Feb. 5, 2026

(54) METHOD AND SYSTEM FOR DESIGN DATA CHANGE CONTROL AND SOLUTION GENERATION OF ELECTROMECHANICAL PRODUCT

(71) Applicant: Sichuan University, Chengdu (CN)

(72) Inventors: Wenqiang LI, Chengdu (CN); Lanjiang ZHENG, Chengdu (CN); Hu CAI, Chengdu (CN); Yida HONG, Chengdu (CN); Xianglong LI, Chengdu (CN)

(21) Appl. No.: 19/270,568

(22) Filed: Jul. 16, 2025

(30) Foreign Application Priority Data
Jul. 23, 2024 (CN) 202410986966.0

(51) Int. Cl. G05B 19/4097

(52) U.S. Cl. CPC G05B 19/4097; G05B 2219/35031

(57) ABSTRACT

A method for design data change control and solution generation for an electromechanical product is provided. A first change event is received. The first change event includes a first change priority. If the first change priority is higher than a second change priority of a second change event that is currently executed, and a change buffer time of the second change event ends or execution of the second change event is completed within the change buffer time, design data of the electromechanical product is changed based on the first change event to obtain a change result. The change buffer time is configured to characterize a time during which the second change event is able to be continuously executed when switching to a change event with a higher execution priority. An electromechanical product design solution is generated based on the change result.

### CROSS-REFERENCE TO RELATED APPLICATIONS

This application claims the benefit of priority from Chinese Patent Application No. 202410986966.0, filed on Jul. 23, 2024. The content of the aforementioned application, including any intervening amendments made thereto, is incorporated herein by reference in its entirety.

### TECHNICAL FIELD

This application relates to data processing, and more particularly to a method and system for design data change control and solution generation of an electromechanical product.

### BACKGROUND

The development of electromechanical products involves improvements in design, production and manufacturing, or service models, with innovation being the core focus. With the continuous development of the economy, the innovative design of electromechanical products has become increasingly complex, diverse, and customized. In order to meet the usage requirements of electromechanical products and ensure design quality and efficiency, it is essential to enable multiple types of participants to engage in the innovative design process.

However, in the process of involving multiple participants in the innovative design of electromechanical products, the fact that multiple stakeholders can propose changes to the design may lead to change conflicts, resulting in inefficiencies in the design process.

### SUMMARY

An object of the disclosure is to provide a method and system for design data change control and solution generation of an electromechanical product, so as to resolve change conflicts and improve design efficiency of electromechanical products when multiple participants propose changes to the design data.

In order to achieve the above object, the following technical solutions are adopted.

In a first aspect, this application provides a method for design data change control and solution generation for an electromechanical product, comprising:
(1) receiving a first change event, wherein the first change event comprises a first change priority;
(2) if the first change priority is higher than a second change priority of a second change event that is currently executed, and a change buffer time of the second change event ends or execution of the second change event is completed within the change buffer time, changing design data of the electromechanical product based on the first change event to obtain a change result, wherein the change buffer time is configured to characterize a time during which the second change event is able to be continuously executed when switching to a change event with a higher execution priority; and
(3) generating an electromechanical product design solution based on the change result.

In the embodiments of the disclosure, the change event to be executed currently is determined by comparing priorities of change events, so that change events with higher priorities are processed first. At the same time, when a change is needed, a change buffer time is set for the event being executed, allowing the event to change smoothly rather than being abruptly interrupted. This improves the stability of change event execution and enhances the design efficiency of electromechanical products.

In some embodiments, the first change event includes a change object; and
the method further comprises:
   after the change buffer time ends or the execution of the second change event is completed within the change buffer time, if the change object is in a state of undergoing change, placing the first change event into a corresponding ready queue for pending processing based on the first change priority; and
   if the change object is in a state of not undergoing change, performing the step of changing the design data based on the first change event.

In the embodiments of the present disclosure, it is considered that different events may change the same change object. Therefore, if the change object is in the state of undergoing change, the current change event is placed into the ready queue for pending processing, so that the object that is currently changed is not affected by the current change event.

In some embodiments, the method further comprises:
if the execution of the second change event is not completed within the change buffer time, placing the second change event into a corresponding ready queue for pending processing according to the second change priority.

The embodiments of the present disclosure consider that the change event that is currently executed may not be completed within the change buffer time, and is thus placed into the corresponding ready queue for pending processing, so that each change event is properly and completely processed, improving the integrity and accuracy of event processing.

In some embodiments, the method further comprises:
after receiving a change request, if the first change priority is not higher than the second change priority, placing the first change event into the corresponding ready queue for pending processing based on the first change priority.

In the embodiments of this application, change events with lower priorities are placed into the corresponding ready queue for pending processing. This ensures that the change event executed each time is the one with the highest current priority, thus improving the design efficiency of electromechanical products.

In some embodiments, the method further comprises:
updating a change priority of a historical change event that is not completely executed using a pending time of the historical change event according to a preset update cycle to obtain an updated change priority; wherein the pending time is configured to characterize a total duration during which the historical change event is in a pending state before a current update cycle; and
placing the historical change event into a corresponding ready queue for pending processing according to the updated change priority.

In the embodiments of this application, the priorities of historical change events in the ready queue are updated. This enables dynamic changes in the priority of each historical change event that has not been completed, ensuring timely processing of these events, thereby improving the design efficiency of electromechanical products.

In some embodiments, a change priority calculation equation is expressed as:

$${W}_{Q} = {ω}_{1} {P}_{CRQ} + {ω}_{2} {T}_{CRQ} + {ω}_{3} {C}_{CRQ} ,$$

wherein [symbol] represents a change priority, ω₁, ω₂ and ω₃ represent weights, [symbol] represents a role priority of a participant, [symbol] represents a custom parameter, and [symbol] represents a pending time.

In the embodiments of the present application, when calculating the change priority, the role of the participant, the custom parameter and the pending time are all considered. Through comprehensive consideration of multiple influencing factors, the priority of each change event is made more reasonable. Moreover, since the pending time is constantly changed, the priority of each change event is also dynamically updated, allowing for timely processing of each change event.

In some embodiments, the method further comprises:
after generating the electromechanical product design solution, performing visual display on the electromechanical product design solution based on the change result.

In the embodiments of the present application, each time a change event is completely executed, the electromechanical product design solution is visually displayed. This facilitates users to be able to intuitively understand the change result, thereby understanding the entire electromechanical product design data.

In a second aspect, this application provides a system for design data change control and solution generation for an electromechanical product, comprising:
a login module;
a change module; and
a display module;
wherein the login module is configured for a user to log in based on user information;
the change module is configured to execute the above method; and
the display module is configured to execute the above method.

In a third aspect, this application provides a device for design data change control and solution generation for an electromechanical product, comprising:
a receiving module;
a change module; and
a generation module;
wherein the receiving module is configured to receive a first change event; and the first change event comprises a first change priority;
the change module is configured to perform steps of:
   if the first change priority is higher than a second change priority of a second change event that is currently executed, and a change buffer time of the second change event ends or execution of the second change event is completed within the change buffer time, changing design data of the electromechanical product based on the first change event to obtain a change result, wherein the change buffer time is configured to characterize a time during which the second change event is able to be continuously executed when switching to a change event with a higher execution priority;
   the generation module is configured to generate an electromechanical product design solution based on the change result.

In a fourth aspect, this application provides an electronic device, comprising:
a processor;
a memory;
a storage medium; and
a bus;
wherein communication between the processor and the memory is achieved through the bus; a program instruction is stored on the memory, and is configured to be executed by the processor to implement the method in the first aspect.

In a fifth aspect, this application provides a non-transitory computer-readable storage medium, wherein a computer program is stored on the non-transitory computer-readable storage medium; and the computer program is configured to be executed by a processor to implement the method in the first aspect.

In a sixth aspect, this application provides a computer program product, comprising:
a computer program;
wherein the computer program is configured to be executed by a processor to implement the method in the first aspect.

Other features and beneficial effects of the present disclosure will be set forth in the subsequent description. Furthermore, some aspects may become apparent from the description or be understood through the implementation of the present disclosure.

### BRIEF DESCRIPTION OF THE DRAWINGS

In order to more clearly illustrate the technical solutions in the embodiments of the present disclosure or in the prior art, the drawings needed in the description of embodiments will be briefly introduced below. It should be understood that presented in the drawings are only some embodiments of the present disclosure, which are not intended to limit the disclosure. For those of ordinary skill in the art, other drawings can be obtained based on these drawings without exerting creative efforts.

FIG. 1 is a schematic diagram of a design data management and change feedback framework in accordance with an embodiment of the present disclosure;

FIG. 2 shows a visualization view of user topic data in a two-tuple form in accordance with an embodiment of the present disclosure;

FIG. 3 shows a visualization view of user topic data in a three-tuple form in accordance with an embodiment of the present disclosure;

FIG. 4 shows a visualization view of design tool data in accordance with an embodiment of the present disclosure;

FIG. 5 shows a visualization view of design tool data in accordance with another embodiment of the present disclosure;

FIG. 6 is a schematic diagram of a design solution data model in accordance with an embodiment of the present disclosure;

FIG. 7 shows a visualization view of design solution data in accordance with an embodiment of the present disclosure;

FIG. 8 is a schematic diagram of an electromechanical product design process involving multiple types of participants in accordance with an embodiment of the present disclosure;

FIG. 9 is a flow chart of a method for design data change control and solution generation for an electromechanical product in accordance with an embodiment of the present disclosure;

FIG. 10 is a schematic diagram of a change conflict resolution process in accordance with an embodiment of the present disclosure;

FIG. 11 is a structural diagram of a multi-level ready queue in accordance with an embodiment of the present disclosure;

FIG. 12 is a schematic diagram of a design data feedback process in accordance with an embodiment of the present disclosure;

FIG. 13 is a flow chart of a change activity control process in accordance with an embodiment of the present disclosure;

FIG. 14 is a structural diagram of a device for design data change control and solution generation for the electromechanical product in accordance with an embodiment of the present disclosure;

FIG. 15 is a structural diagram of an electronic device in accordance with an embodiment of the present disclosure; and

FIG. 16 is a structural diagram of a system for design data change control and solution generation for the electromechanical product in accordance with an embodiment of the present disclosure.

### DETAILED DESCRIPTION OF EMBODIMENTS

The embodiments of the present disclosure will be described in detail below with reference to the accompanying drawings. The following embodiments are merely intended to illustrate the technical solutions of the present disclosure more clearly and are therefore illustrative, and are not intended to limit the scope of this application.

It should be noted that all technical and scientific terms used herein have the same meaning as commonly understood by those of ordinary skill in the art. The terms used herein are only intended to describe the embodiments, and are not intended to limit the present disclosure. Terms “comprise” and “include” as well as any variations thereof in the description and claims of this application and the above description of the drawings are intended to cover non-exclusive inclusion.

In the description of the embodiments, technical terms such as “first” and “second” are only used to distinguish different objects, and should not be construed as indicating or implying relative importance or implicitly specifying the number, specific order, or primary-secondary relationship of the indicated technical features. In the description of the embodiments, the term “a plurality of” means two or more, unless otherwise explicitly and specifically defined.

The development of electromechanical products involves improvements in design, production manufacturing or service models, with innovation of the electromechanical products being the core focus. With the increasing development of the economy, the innovative design of electromechanical products has become more complex, diverse and customized. In order to meet the usage requirements of electromechanical products and ensure product design quality and efficiency, it is necessary to enable multiple types of participants to engage in the electromechanical product innovation design process. Achieving interaction and feedback among design information data, visualization views and multiple types of participants is fundamental to supporting the innovative design of electromechanical products and establishing a change feedback process for participant-involved design data.

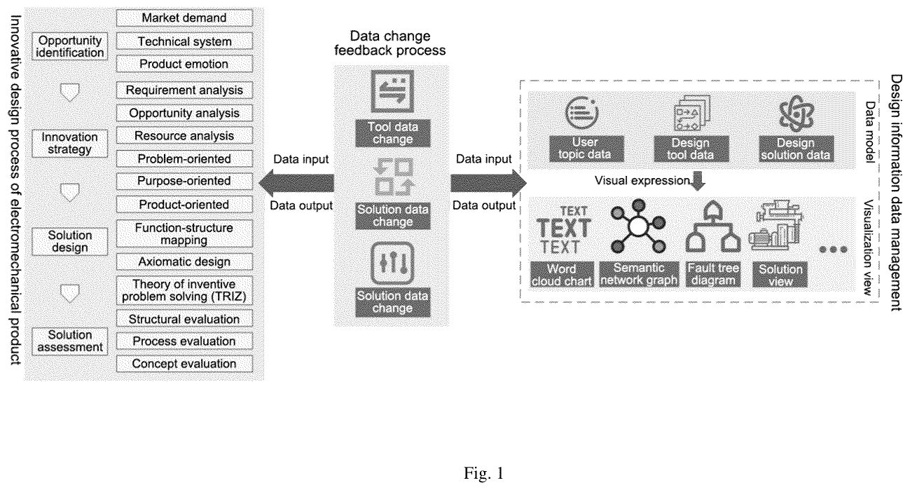

FIG. 1 is a schematic diagram of a design data management and change feedback framework in accordance with an embodiment of the present disclosure. As shown in FIG. 1, the framework includes three sections, namely an innovative design process of the electromechanical product, a data change feedback process and design information data management. The data change feedback process is configured to be executed when data input and output are performed between the electromechanical product innovative design process section and the design information data management section.

Design information data involved in the design information data management includes user topic data, design tool data and design solution data. The user topic data, the design tool data and the design solution data are visually expressed.

Methods of visual expression include, but are not limited to, word clouds, semantic network diagrams, fault tree diagrams and solution views.

The user topic data primarily appears in the form of words that can reflect a certain function, feature, or form of a solution or product, and is thus referred to as topic words. The user topic data is obtained from a large amount of comment text and solution text through topic word extraction technology, which mostly comes from users of the electromechanical products.

The user topic data is stored in a database in the form of a two-tuple <topic word, topic word frequency>or a three-tuple <topic word 1, topic word 2, co-occurrence frequency>, and serves as a basis for constructing visualization views.

In a case where the user topic data is in the form of two-tuple data, it can reflect user demands in a certain aspect such as product structure function or product characteristic performance. In a case where the user topic data is in the form of three-tuple data, it can reflect implicit relationships among the product structure function, characteristic performance and product appearance. Participants involved in electromechanical product design need to complete the design of solutions based on the user topic data to meet user requirements.

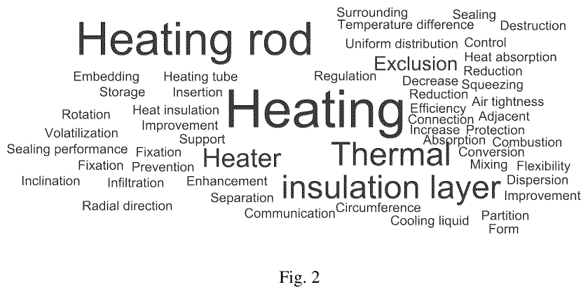

FIG. 2 is a visualization view of the user topic data in a two-tuple form provided in an embodiment of the present application. As shown in FIG. 2, the user topic data includes topic words such as heating rod, heating, heater, thermal insulation layer, surrounding, heat insulation and connection, which reflect product functions or product characteristic performance.

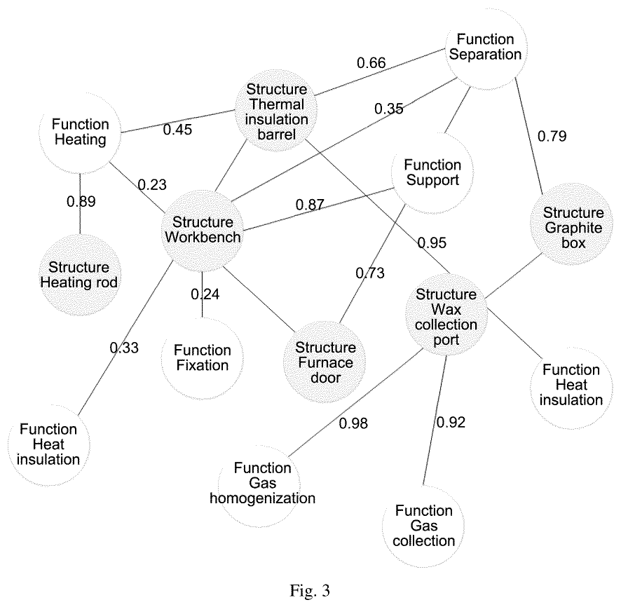

FIG. 3 is a visualization view of the user topic data in a three-tuple form provided in an embodiment of the present application. As shown in FIG. 3, the user topic data includes topic words reflecting the structural functions of the electromechanical products, such as structural insulation barrel and functional separation, as well as implicit relationships between the topic words, for example, the number 0.66 on the line connecting the structural insulation barrel and the functional separation.

The design tool data adopts innovative design tools as a carrier and already has a fixed visual form and data model. The design tool data reflects the design intent of the participants during the product innovation design process. Different innovative design theories and methods are used during product innovation design. The design tool data is the information carried by the innovative tools in these innovative methods or theories, and thus mainly originates from conceptual designers, who generate a large amount of the design tool data during historical innovation design processes of similar products. The design tool data mainly includes basic data of the electromechanical product and data relationships. The design tool data is generated during the product design process by conceptual designers.

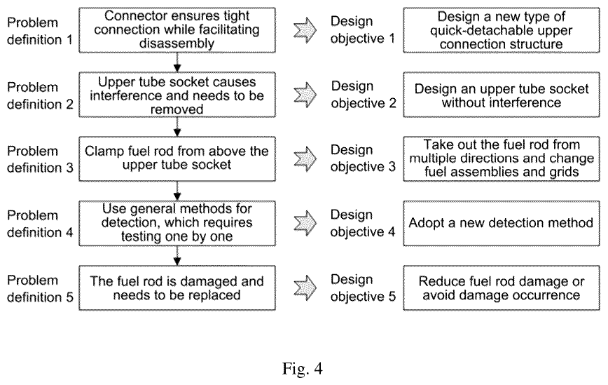

FIG. 4 is a visualization view of the design tool data provided in an embodiment of the present application. As shown in FIG. 4, the design tool data is a causal analysis view, including problem definition and design objectives.

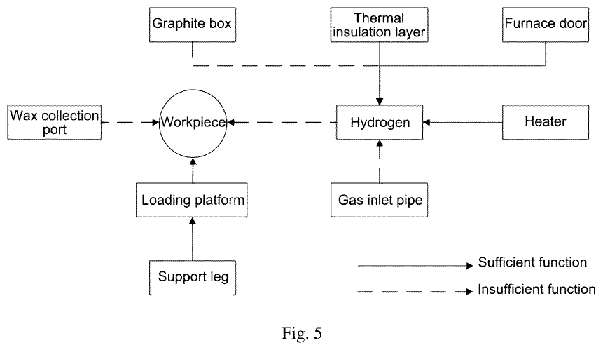

FIG. 5 is another visualization view of the design tool data provided in an embodiment of the present application. As shown in FIG. 5, the design tool data is a functional component analysis view, including various functional components, relationships therebetween and roles thereof.

The design solution data is directed to the product concept solution obtained through the electromechanical product innovation design process, which also contains data on various aspects of the product. The design solution data includes simple component shape information, function and requirement information reflecting the product innovation design process, cost and importance information reflecting change feedback, etc. The combination of these, which reflects geometric features of the product solution and the design process data, constitutes the design solution data. The design solution data includes structural data and structural relationships.

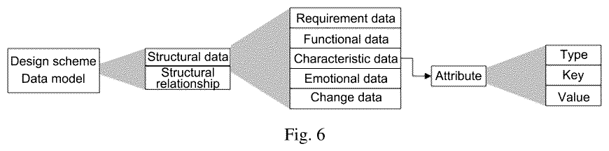

FIG. 6 is a schematic diagram of a design solution data model provided in an embodiment of the present application. As shown in FIG. 6, the data model includes structural data and structural relationships. The structural data includes requirement data, functional data, characteristic data, emotional data, change data, etc. The characteristic data includes attribute, and the attribute includes data such as type, key, and value.

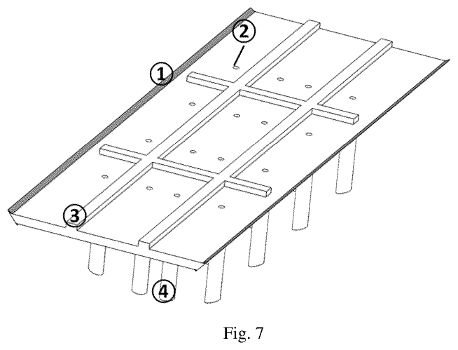

FIG. 7 is a visualization view of the design solution data provided in an embodiment of the present application. As shown in FIG. 7, the design solution data is for the design solution of a loading platform, including correlation information of a sealing structure 1, a gas exhaust port 2, support frame 3, and hollow support legs 4. Specifically, the correlation information contains the following items.
Structural information: Sealing structure
Functional information: Sealing
Requirement information: Prevent gas flow between a sintering space at an upper part and a lower part of the loading platform.
Design time: 0.8 h
Design cost:
Structural information: Gas exhaust port
Functional information: Gas exhaustion
Requirement information: The sintering space needs to discharge the wax vapor generated during sintering of an object.
Design time: 3.1 h
Design cost:
Structural information: Support frame
Functional information: Support
Requirement information: Support the sintered object to prevent blockage of the gas exhaust port.
Design time: 1.5 h
Design cost:
Structural information: Hollow support leg
Functional information: Support and exhaust
Requirement information: Support the loading platform and allow the gas discharged from the air channel to enter the gas collection box.
Design time: 2.5 h
Design cost:

The design information data management is performed by constructing appropriate data models and databases to store the user topic data, the design tool data and the design solution data generated during the electromechanical product innovation design process. This serves as the foundation for multiple types of participants to engage in the product design process and to achieve data change feedback.

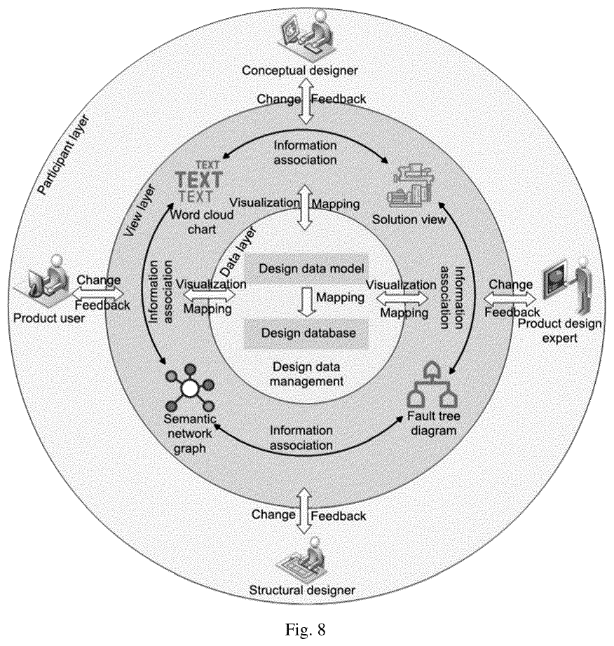

FIG. 8 is a schematic diagram of an electromechanical product design process involving multiple types of participants according to an embodiment of the present application. As shown in FIG. 8, the participant layer is configured to display participants involved in the electromechanical product design, which are divided into four types, including the product user, structural designer, product design expert and conceptual designer. Each type of participant may include multiple personnels.

The view layer is configured to display visualization views, including the word cloud chart, solution view, fault tree diagram and semantic network graph.

The data layer is configured for design data management, including a design data model and a design database.

The design data of the data layer is visually mapped to the view layer. Change feedback is performed between the view layer and the participant layer. The changed data is stored in the design database of the data layer. The views in the view layer are also correspondingly changed and fed back to other participants.

Based on the content shown in FIG. 8, it can be understood that multiple participants may perform change activities on the same view during the electromechanical product design process. In order to facilitate the transfer of relevant data among various participants and avoid conflicts during the change process, the data change process needs to be effectively controlled to improve the design efficiency of electromechanical products.

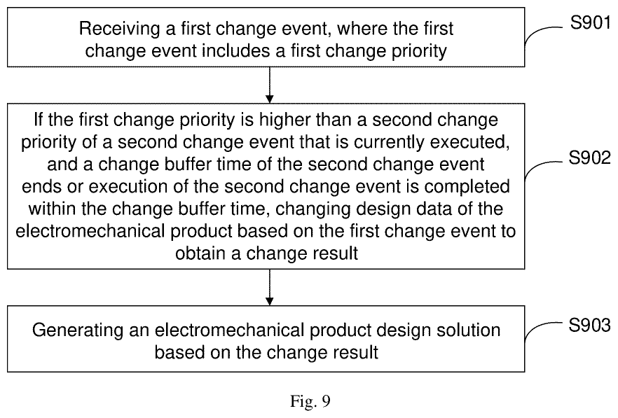

FIG. 9 is a flow chart of a method for design data change control and solution generation for an electromechanical product according to an embodiment of the present application. It can be understood that the method provided herein can be applied to terminal devices (which may also be referred to as electronic devices) and servers. The terminal device may specifically be a smartphone, a tablet computer, a computer, a personal digital assistant (PDA), etc. The server may specifically be an application server or a Web server. In order to facilitate understanding of the technical solutions provided in the embodiments of the present application, the application scenario of the above method is introduced below by taking a server as an execution subject.

As shown in FIG. 9, the method includes the following steps.

Step (901) A first change event is received by the server. The first change event includes a first change priority.

In an embodiment, when a participant finds, through a visualization view, that design data of the electromechanical product needs to be changed, a location in the visualization view that requires change is clicked to trigger the first change event. The server receives the first change event to determine whether the design data of the electromechanical product in the visualization view needs to be changed based on the first change event.

The clicking can be performed by the participant using a mouse click or can be manually triggered by the participant.

Whether the design data of the electromechanical product in the visualization view needs to be changed based on the first change event is determined by the server determines through the first change priority of the first change event.

Step (902) If the first change priority is higher than a second change priority of a second change event that is currently executed, and a change buffer time of the second change event ends or execution of the second change event is completed within the change buffer time, the design data of the electromechanical product is changed by the server based on the first change event to obtain a change result. The change buffer time is configured to characterize a time during which the change event being executed can continue to be executed when switching to a change event with a higher execution priority.

Step (903) An electromechanical product design solution is generated according to the change result.

In an embodiment, since multiple participants can change the design data of the electromechanical product, when the first change event is received by the server, a second change event may already be being executed in the execution program.

At this time, the first change priority needs to be compared with the second change priority of the second change event. If the first change priority is higher than the second change priority of the second change event that is currently executed, it indicates that the first change event with a higher priority needs to be executed currently.

However, for the purpose of realizing smooth switching between different change events, a change buffer time is set in advance for each change event. In some embodiments, different change events may have the same or different corresponding change buffer times.

The change buffer time is configured to characterize the time during which the change event being executed can continue to be executed when switching to a change event with a higher execution priority.

The change buffer time can effectively reduce performance overhead caused by frequent switching and predict the execution rhythm of tasks to a certain extent, thereby avoiding system oscillation caused by sudden tasks.

Therefore, if the first change priority is higher than the second change priority of the second change event currently being executed, and the change buffer time of the second change event ends or execution of the second change event is completed within the change buffer time, the electromechanical product design data is changed by the server based on the first change event to obtain the change result. The electromechanical product design solution is generated according to the change result.

In an embodiment, when product user Chen and detailed designer Zhang simultaneously propose change requests, according to preset change priorities, it can be determined that change event ce₂ has a higher change priority, so ce₁ enters the ready queue and ce₂ is executed. Subsequently, product user Liu proposes a new change request, at which time a change conflict arises. The change priority of change event ce₃ is greater than that of ce₂, so ce₂ enters the ready queue after the change buffer time of ce₂ ends, and c₃ is executed. After execution of ce₃ is completed, a change result is obtained, and an electromechanical product design solution is generated based on the change result of ce₃.

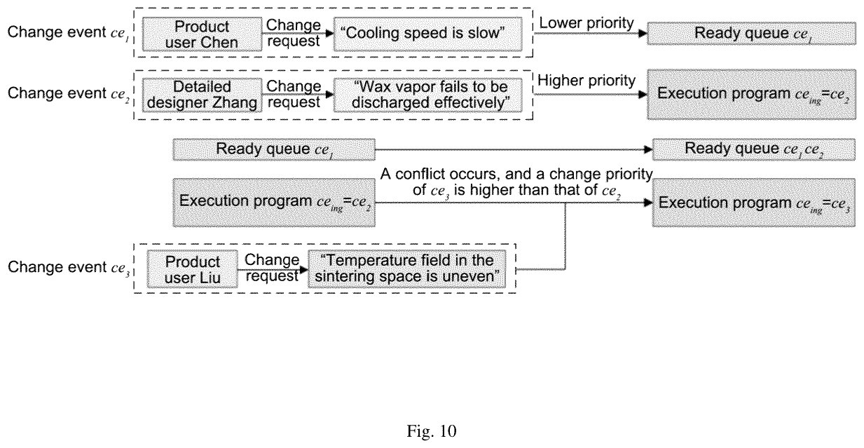

FIG. 10 is a schematic diagram of a change conflict resolution process provided in an embodiment of the present application. Regarding change event ce₁, Chen proposes the change request “cooling speed is slow” with a relative low change priority, and is stored in the corresponding ready queue. Regarding change event ce₂, Zhang proposes the change request “Wax vapor fails to be discharged effectively” with a relatively high change priority. At this time, the execution program executes ce_{ing}=ce₂. Subsequently, regarding change event ce₃, Liu proposes the change request “temperature field in the sintering space is uneven” with a change priority higher than ce₂. At this time, ce₂ is also stored in the corresponding ready queue, and the execution program executes ce_{ing}=ce₃.

After the execution of ce₃ is completed, the latest generated electromechanical product design solution includes the design information of “temperature field in the sintering space is uneven”.

In the embodiments of the present application, the change event that currently needs to be executed is determined by comparing the priorities of the change events, so that change events with higher priorities are processed first. At the same time, when a change is needed, a change buffer time is set for the event being executed, allowing the event to change smoothly rather than being abruptly interrupted. This improves the stability of change event execution and enhances the design efficiency of electromechanical products.

In some embodiments, the first change event includes a change object. After the change buffer time of the second change event ends or the execution of the second change event is completed within the change buffer time, the method further includes the following steps. If the change object is in a state of undergoing change, the first change event is placed into the corresponding ready queue for pending processing based on the first change priority. If the change object is in a state of not undergoing change, the step of changing the electromechanical product design data based on the first change event is performed.

In an embodiment, since multiple participants can change the design data of the electromechanical product, different participants may change the same object of the electromechanical product design data. For example, both participants change a height of a support frame of the loading platform.

At this time, the state of the change object of the first change event needs to be determined. If the change object is in the state of undergoing change, the first change event is placed into the corresponding ready queue for pending processing based on the first change priority. In order to ensure that all historical change events stored in the ready queues can be processed in a timely manner, the change event with the highest priority among other events is executed at this time.

If the change object is in the state of not undergoing change, the electromechanical product design data is changed based on the first change event.

It should be noted that since the change event executed each time is the one with the highest current change priority, and although a change buffer time is set for each change event, execution of the change event may not necessarily be completed within the change buffer time. Therefore, a change event may be interrupted when only half executed. At this time, the state of the change object of the interrupted change event is still regarded as “undergoing change”. In this state, even if the first change event has a higher change priority, it is still not executed and is placed into the corresponding ready queue for pending processing.

The embodiments of the present application consider that different events may change the same change object. Therefore, if the change object is in the state of undergoing change, the current change event is placed into the ready queue for pending processing, so that the object that is currently changed is not affected by the current change event.

In some embodiments, the method further includes the following step. If the execution of the second change event is not completed within the change buffer time, the second change event is placed into the corresponding ready queue by the server for pending processing according to the second change priority.

In an embodiment, since the purpose of the change buffer time is to smoothly switch change events, this change buffer time is commonly a short time, for example, a few seconds or tens of seconds.

If the second change event has only just been executed and is a long-task-type change event, the second change event fails to be fully executed within the change buffer time. In order to ensure the integrity of change event execution, the second change event needs to be placed into the corresponding ready queue according to the second change priority for pending processing.

The embodiments of the present application consider that the change event that is currently executed may not be completed within the change buffer time, and is thus placed into the corresponding ready queue for pending processing, so that each change event is properly and completely processed, improving the integrity and accuracy of event processing.

In some embodiments, after receiving the change request, the method further includes the following step. If the first change priority is not higher than the second change priority of the second change event that is currently executed, the first change event is placed into the corresponding ready queue based on the first change priority for pending processing.

In an embodiment, since the server determines whether to execute the first change event by comparing the change priority of the first change event with that of the second change event, and the first change priority of the first change event may be less than or equal to the second change priority of the second change event, the first change event is placed into the corresponding ready queue for pending processing.

In the embodiments of the present application, change events with lower priorities are placed into the corresponding ready queue for pending processing. This ensures that the change event executed each time is the one with the highest current priority, thus improving the design efficiency of electromechanical products.

In some embodiments, the method further includes the following step. The change priorities of historical change events are updated according to a preset update cycle by using a pending time of the historical change events that are not completely executed. The pending time is configured to characterize a total duration for which the change event is in a pending state before the current update cycle. The historical change events that are not completely executed are placed into the corresponding ready queue according to the updated change priorities for pending processing.

In an embodiment, considering that if the change priority of a change event remains unchanged, events with low priority may never be processed. Therefore, in order to ensure that each change event is properly and timely processed, the change priorities of historical change events that are received by the server but not executed are updated according to the preset update cycle.

In some embodiments, the pending time of the historical change events that are not completely executed is used to update the change priorities of the corresponding historical change events. The historical change events that are not completely executed are placed into the corresponding ready queue according to the updated change priorities for pending processing.

It should be noted that different ready queues are used to store change events with different priorities. For example, change events with a change priority of 1 is stored in ready queue 1, change events with a change priority of 2 is stored in ready queue 2, and change events with a change priority of 3 is stored in ready queue 3.

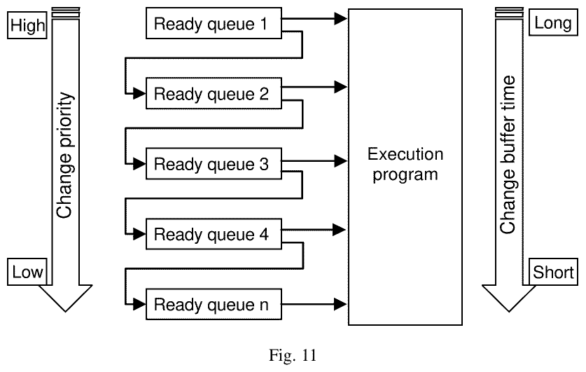

FIG. 11 is a structural diagram of a multi-level ready queue provided in an embodiment of the present application. As shown in FIG. 11, the multi-level ready queue includes ready queue 1, ready queue 2, ready queue 3, ready queue 4 and ready queue n, with change priorities from high to low. Each ready queue interacts with the execution program so that the change events in the ready queues are executed in the execution program. As shown in FIG. 10, the change buffer time shortens as the change priority decreases.

When the change priority of a historical change event changes, the historical change event is placed into the corresponding ready queue based on the updated change priority.

It should be noted that the change priority of a historical change event can be calculated based on the change priority calculation equation provided in the following embodiment.

In the embodiments of the present application, by updating the priorities of historical change events in the ready queues, the priority of each historical change event that are not completely executed changes dynamically. This enables timely processing of these events, thereby improving the design efficiency of electromechanical products.

In some embodiments, the change priority is calculated through the following equation:

$${W}_{Q} = {ω}_{1} {P}_{CRQ} + {ω}_{2} {T}_{CRQ} + {ω}_{3} {C}_{CRQ} .$$

In the above equation, [symbol] represents the change priority, ω₁, ω₂ and ω₃ represent weights, [symbol] represents a role priority of a participant, [symbol] represents a custom parameter, and [symbol] represents the pending time.

In an embodiment, ω₁, ω₂ and ω₃ represent the weights of [symbol] , [symbol] and [symbol] , respectively. Each weight can be set based on expert experience or can be obtained based on an entropy weight method.

[symbol] represents the role priority of the participant. Based on the foregoing embodiments, it can be seen that the participant types include the product user, structural designer, product design expert and conceptual designer. In an embodiment, the [symbol] of the product user is defined as 1, the [symbol] of the structural designer is defined as 2, and the [symbol] of the product design expert and the conceptual designer is defined as 3.

[symbol] represents the custom parameter that is configured to assign different priorities even to the same role. For example, product user A and product user B have differences in product understanding and design experience.

[symbol] represents the pending time that is configured to characterize the total duration for which the change event is in a pending state before the current update cycle. For example, if the current update cycle is the third update cycle, and event α is in a pending state for a duration of tₐ in the first update cycle and for a duration of t_{b} in the second update cycle, then the pending time is tₐ+t_{b}.

The change priority of the change event is stored in queue CR_ [symbol] ueue, expressed as follows:

$$CR\_Queue = \{ {W}_{Q 1} , {W}_{Q 2} , ... , {W}_{Qn} \} .$$

[symbol] represents a change priority of an i-th change event, where 1≤i≤n.

In the embodiments of the present application, when calculating the change priority, the role of the participant, the custom parameter and the pending time are all considered. Through comprehensive consideration of multiple influencing factors, the priority of each change event is made more reasonable. Moreover, since the pending time is constantly changed, the priority of each change event is also dynamically updated, allowing for timely processing of each change event.

In some embodiments, the method further includes the following step. After the electromechanical product design solution is generated by the server according to the change result, the electromechanical product design solution is visually displayed by the server based on the change result.

In an embodiment, after the execution of the first change event is completed, the design data of the electromechanical product is visually displayed by the server based on the change result, so that other participants can observe the change result.

Therefore, the design data after the change is completed is fed back to the corresponding database and design views. Other participants can also observe the changes in the design data through the design views.

In the embodiments of the present application, each time a change event is completely executed, the electromechanical product design solution is visually displayed. This facilitates users to be able to intuitively understand the change result, thereby understanding the entire electromechanical product design data.

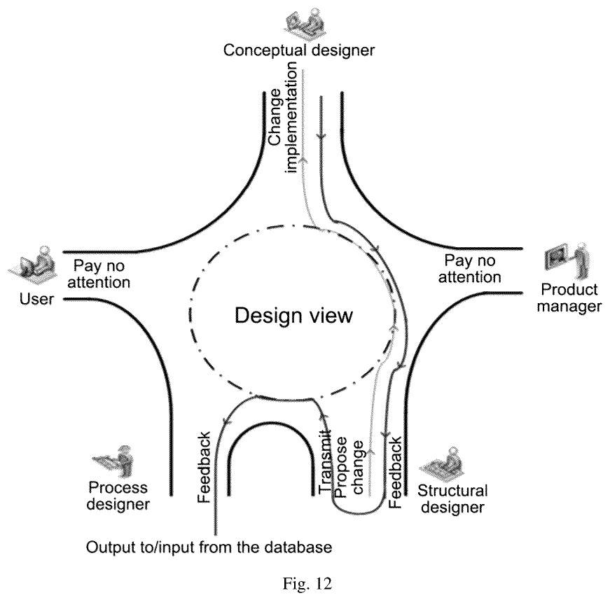

FIG. 12 is a schematic diagram of a design data feedback process provided in an embodiment of the present application. As shown in FIG. 12, a structural designer proposes a change request. After the change is implemented, the updated visualization view and the corresponding design data are fed back to the structural designer and other designers who focus on the view.

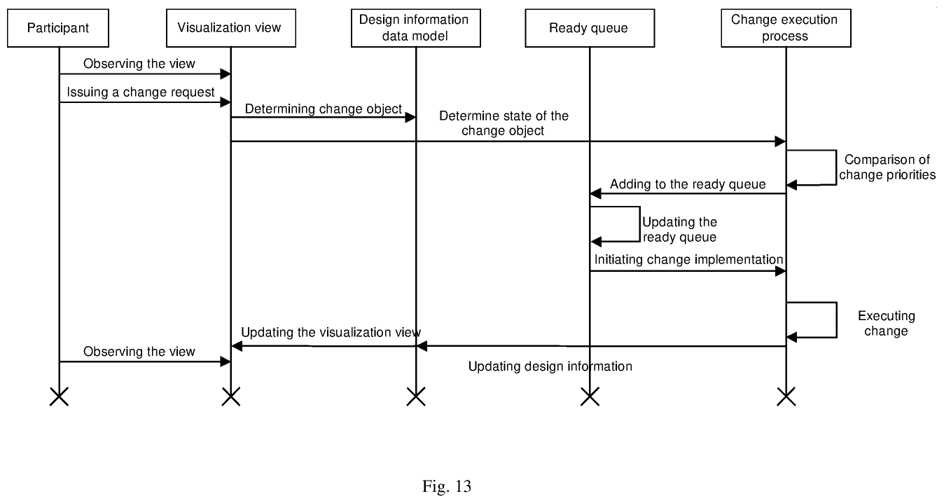

FIG. 13 is a flow chart of a change activity control process provided in an embodiment of the present application. As shown in FIG. 13, participants observe the visualization view, and when it is found that the design data of the electromechanical product needs to be changed, a change request is issued to form a change event. The change object in the design information data model is determined based on the change request, and the state of the change object is determined. During the change execution process, change priorities are compared. If a change has a lower priority, it is added to the corresponding ready queue for pending processing. The ready queue is updated according to a preset update cycle. The change event with the highest current change priority is selected to initiate the change implementation. The change is executed to update the design information and update the visualization view. Finally, participants observe the view.

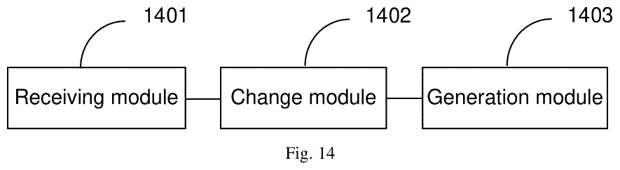

FIG. 14 is a structural diagram of a device for electromechanical product design data change control and solution generation provided in an embodiment of the present application. As shown in FIG. 14, the device includes a receiving module 1401, a change module 1402 and a generation module 1403.

The receiving module 1401 is configured to receive a first change event. The first change event includes a first change priority. The change module 1402 is configured to change design data of the electromechanical product based on the first change event if the first change priority is higher than a second change priority of a second change event currently being executed, and a change buffer time of the second change event ends or the execution of the second change event is completed within the change buffer time. The change buffer time is configured to characterize a time during which the change event being executed can continue to be executed when switching to a change event with a higher execution priority. The generation module 1403 is configured to generate an electromechanical product design solution according to the change result.

On the basis of the foregoing embodiments, the first change event includes a change object. The change module 1402 is specifically configured to place the first change event into the corresponding ready queue for pending processing based on the first change priority if the change object is in a state of undergoing change, and execute the step of changing the design data based on the first change event if the change object is in a state of not undergoing change.

On the basis of the foregoing embodiments, the change module 1402 is specifically configured to place the second change event into the corresponding ready queue according to the second change priority for pending processing if the second change event is not executed completely within the change buffer time.

On the basis of the foregoing embodiments, the device further includes a pending module, which is configured to place the first change event into the corresponding ready queue based on the first change priority for pending processing if the first change priority is not higher than the second change priority of the second change event that is currently executed.

On the basis of the foregoing embodiments, the device further includes a priority updating module, which is configured to update change priorities of historical change events that are not completely executed according to a preset update cycle by using a pending time of the historical change events that are not completely executed. The pending time is configured to characterize a total duration for which the change event is in a pending state before the current update cycle. The historical change events that are not completely executed are placed into the corresponding ready queue according to the updated change priorities for pending processing.

On the basis of the foregoing embodiments, the device further includes a priority calculation module. The change priority is calculated through the following equation:

$${W}_{Q} = {ω}_{1} {P}_{CRQ} + {ω}_{2} {T}_{CRQ} + {ω}_{3} {C}_{CRQ} .$$

In the above equation, [symbol] represents the change priority, ω₁, ω₂ and ω₃ represent weights, [symbol] represents a role priority of a participant, [symbol] represents a custom parameter, and [symbol] represents the pending time.

On the basis of the foregoing embodiments, the device further includes a visualization display module, which is configured to visually display the electromechanical product design solution based on the change result.

It should be understood that the device corresponds to the embodiment of the method described above, and can perform the various steps involved in the above method. The specific functions of the device can be referred to the description above. Detailed description is appropriately omitted here to avoid repetition. The device includes at least one software functional module that can be stored in a memory in the form of software or firmware, or solidified in the operating system (OS) of the device.

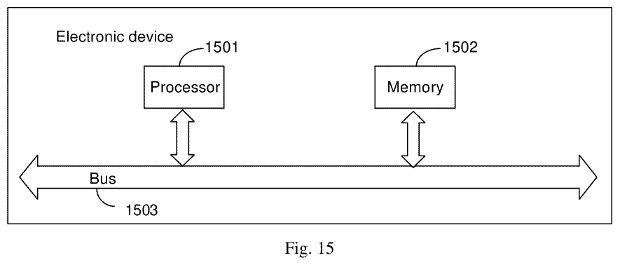

FIG. 15 is a structural diagram of an electronic device provided in an embodiment of the present application. As shown in FIG. 15, the electronic device includes a processor 1501, a memory 1502 and a bus 1503. Communication between the processor 1501 and the memory 1502 is achieved through the bus 1503. The processor 1501 is configured to invoke program instructions in the memory 1502 to execute the above method.

The processor 1501 can be an integrated circuit chip with signal processing capability. The processor 1501 can be a general-purpose processor, including a central processing unit (CPU), a network processor (NP), etc., and can also be a digital signal processor (DSP), an application-specific integrated circuit (ASIC), a field-programmable gate array (FPGA) or other programmable logic device, a discrete gate or transistor logic device, or a discrete hardware component. It can implement or execute the various methods, steps, and logic block diagrams disclosed in the embodiments of the present application. The general-purpose processor can be a microprocessor, or the processor can be any conventional processor.

The memory 1502 can include, but is not limited to, a random access memory (RAM), a read-only memory (ROM), a programmable read-only memory (PROM), an erasable programmable read-only memory (EPROM) and an electrically erasable programmable read-only memory (EEPROM).

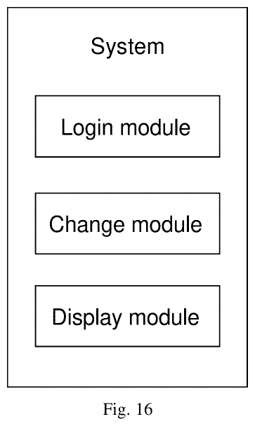

FIG. 16 is a structural diagram of a system for design data change control and solution generation for the electromechanical product provided in an embodiment of the present application. As shown in FIG. 16, the system includes a login module, a change module and a display module.

The login module is configured for a user to log in based on user information. The user information can be user's account+password, user's mobile phone number+verification code, or user's identity document (ID) number+password. Specifically, the corresponding user information can be selected for login according to the actual situation.

The change module is configured to execute the above method described in the foregoing embodiments. That is, a change event is executed based on the change event priority to obtain the change result. The specific process refers to the above embodiments, and will not be repeated here.

The display module is configured to display the generated electromechanical product design solution according to the change result.

This embodiment discloses a computer program product, including a computer program stored on a non-transitory computer-readable storage medium. The computer program includes a program instruction that is configured to be executed by a computer to implement the above method.

This embodiment provides a non-transitory computer-readable storage medium. A computer instruction is stored on the non-transitory computer-readable storage medium. The computer instruction is configured to be executed by a computer to implement the method provided by the above embodiments.

In the embodiments provided in this application, it should be understood that the terminals, devices and methods provided herein can be implemented in other ways. The above devices are merely illustrative. For example, the division of the units is only a logical function division. In practical implementation, there may be other ways of division. For example, multiple units or components can be combined or integrated into another system, or some features can be omitted, or not implemented. On the other hand, the coupling, direct coupling or communication connection between each other shown or discussed herein can be realized through some communication interfaces, and the indirect coupling or communication connection of the devices or units can be in electrical, mechanical or other forms.

In addition, the units described as separate components may or may not be physically separated, and the components displayed as units may or may not be physical units, that is, they may be located in one place or distributed on multiple network units. Some or all of the units may be selected according to actual needs to achieve the purpose of the scheme in the embodiments provided herein.

Furthermore, the functional modules in the embodiments of the present application can be integrated together to form an independent part, or each module can exist alone, or two or more modules can be integrated to form an independent part.

The embodiments disclosed above are merely illustrative of the disclosure, and are not intended to limit the present disclosure. It should be understood that any modifications, changes and replacements made by those skilled in the art without departing from the spirit of the disclosure shall fall within the scope of the disclosure defined by the appended claims.

What is claimed is:

1. A method for design data change control and solution generation for an electromechanical product, comprising:
(1) receiving a first change event, wherein the first change event comprises a first change priority;
(2) if the first change priority is higher than a second change priority of a second change event that is currently executed, and a change buffer time of the second change event ends or execution of the second change event is completed within the change buffer time, changing design data of the electromechanical product based on the first change event to obtain a change result, wherein the change buffer time is configured to characterize a time during which the second change event is able to be continuously executed when switching to a change event with a higher execution priority; and
(3) generating an electromechanical product design solution based on the change result;
wherein the first change event includes a change object; and
the method further comprises:
after the change buffer time ends or the execution of the second change event is completed within the change buffer time, if the change object is in a state of undergoing change, placing the first change event into a corresponding ready queue for pending processing based on the first change priority; and
if the change object is in a state of not undergoing change, performing the step of changing the design data based on the first change event.

2. The method of claim 1, further comprising:
if the execution of the second change event is not completed within the change buffer time, placing the second change event into a corresponding ready queue for pending processing according to the second change priority.

3. The method of claim 1, further comprising:
after receiving a change request, if the first change priority is not higher than the second change priority, placing the first change event into the corresponding ready queue for pending processing based on the first change priority.

4. The method of claim 1, further comprising:
updating a change priority of a historical change event that is not completely executed using a pending time of the historical change event according to a preset update cycle to obtain an updated change priority; wherein the pending time is configured to characterize a total duration during which the historical change event is in a pending state before a current update cycle; and
placing the historical change event into a corresponding ready queue for pending processing according to the updated change priority.

5. The method of claim 1, wherein a change priority calculation equation is expressed as:
$${W}_{Q} = {ω}_{1} {P}_{CRQ} + {ω}_{2} {T}_{CRQ} + {ω}_{3} {C}_{CRQ} ,$$
wherein [symbol] represents a change priority, ω₁, ω₂ and ω₃ represent weights, [symbol] represents a role priority of a participant, [symbol] represents a custom parameter, and [symbol] represents a pending time.

6. The method of claim 1, further comprising:
after generating the electromechanical product design solution, performing visual display on the electromechanical product design solution based on the change result.

7. A system for design data change control and solution generation for an electromechanical product, comprising:
a login module;
a change module; and
a display module;
wherein the login module is configured for a user to log in based on user information;
the change module is configured to execute the method of claim 1; and
the display module is configured to perform visual display of the electromechanical product design solution based on the change result.

8. A computer-readable storage medium, wherein a computer program is stored on the computer-readable storage medium; and the computer program is configured to be executed by a processor to implement the method of claim 1.

9. A computer program product, comprising:
a computer program;
wherein the computer program is configured to be executed by a processor to implement the method of claim 1.
